(19) United States
(12) Patent Application Publication
(10) Pub. No.: US 2007/0169950 A1
(43) Pub. Date: Jul. 26, 2007

(54) Folding soil conditioning farm implement

(75) Inventor: Scott M. Grieshop, Ft. Recovery, OH (US)

Correspondence Address: Alan F. Meckstroth;JACOX, MECKSTROTH & JENKINS, Suite 2, 2310 Far Hills Building, Dayton, OH, 45419-1575, US

(73) Assignee: J. & M. Manufacturing Co., Inc.

(21) Appl. No.: 11/340,272

(22) Filed: Jan. 26, 2006

(51) Int. Cl. A01B 49/00

(52) U.S. Cl. 172/311

(57) ABSTRACT

A folding soil conditioning farm implement includes retractable wheels supporting a center section having a frame including an elongated telescopic and folding tongue and supporting a set of soil conditioning rollers. A pair of wing sections have frames pivotally connected by hinges to opposite sides of the frame of the center section and also carry a set of soil conditioning rollers. The hinges have generally horizontal parallel axes angled with respect to the tongue to provide for folding the wing sections to parallel horizontal tandem positions above the center section for storage and transport. Each set of parallel soil conditioning rollers on each section are mounted on a roller frame connected to the corresponding section frame by parallel spaced depending arms and a set of upper and lower rubber torsion bar axles. Fluid cylinders operate the wheels, wing sections and folding tongue.

### Background of the Invention

This invention relates to soil conditioning farm implements of the general type disclosed in U.S. Pat. No. 4,896,732, No. 5,839,516, No. 6,550,543 and No. 6,860,335. These patents disclose soil conditioning farm implements such as cultipackers or packers with sections having continuously enclosed wheels or rolling harrows having a series of segmented rolling open baskets. The wheels or baskets, herein referred to as rollers, breakup clods of dirt in plowed ground and help to level and/or pack the ground or soil ready for planting. The implements may have substantial width, for example, 40 feet or greater, and thus are constructed in sections which fold for transport and storage. As disclosed in the '732 Patent, the implement includes a center section of rollers and two wing sections of rollers which fold rearwardly from the center section for transport and storage. The '516 Patent, '543 Patent and the '335 Patent each disclose a form of soil conditioning implement wherein the wing sections fold forwardly for transport and storage.

Another form of similar farm implement is disclosed in U.S. Pat. No. 4,867, 245 and includes a wheel supported center frame section which pivotally supports wing frame sections which fold upwardly and downwardly for transport and storage. Similar farm implements with upwardly folding wing sections are produced by Unverferth Manufacturing Co., Inc. and referred to as a “Rolling Harrow II Soil Conditioner” and by Krause Corporation and referred to as a “Flex-Wing Packer”. Another form of farm implement having upwardly folding wing sections is produced by Brillion Farm Equipment Co. and referred to as the “X” Series Pulverizers.

It has been found desirable with any such soil conditioning implement having folding wing sections to provide for effectively breaking up the clods of dirt and leveling the plowed ground uniformly over the entire width of the implement with the wing sections have been pivoted or unfolded to their operating positions. It is also desirable for a wide soil conditioning implement to be able to ride over rocks and debris on the ground without significantly stressing or damaging the implement frame and to fold or collapse into a compact area for transport and storage by having the wing sections fold upwardly and inwardly to positions directly over the center section. This provides the driver of a towing vehicle with greater rear visibility during transport and also provides for transporting the collapsed implement on the bed of a transport truck with a minimum overall combined height of the truck bed and implement.

### SUMMARY OF THE INVENTION

The present invention is directed to an improved soil conditioning farm implement which provides all of the desirable features mentioned above and is especially compact for transport and storage and minimizes stresses on the implement when in use. The soil conditioning implement of the invention also provides high durability and is more economical to maintain in addition to providing for uniform ground pressure across its entire width and for absorbing shock forces produced by rocks or debris in the soil.

In accordance with one embodiment of the invention, a soil conditioning farm implement is constructed with a center section supported by retractable wheels and including a frame with an elongated telescopic and folding tongue. The center section frame also supports a set of soil conditioning members or rollers, and a pair of wing sections have frames pivotally connected by hinges to opposite sides of the center section frame, with each wing section also having a set of soil conditioning members or rollers. The hinges have horizontal and parallel axes which are angled relative to the centerline of the tongue so that the wing sections fold upwardly and inwardly to parallel horizontal tandem positions extending at an angle across the center section for storage and transport of the implement. Each set of parallel soil conditioning members or rollers on each section of the implement are mounted on a support frame connected to a corresponding frame of the section by parallel spaced depending arms and a set of upper and lower rubber torsion bar axles. Fluid or hydraulic cylinders operate the retractable wheels, the folding wing sections and may be used for folding a tongue section.

Other features and advantages of the invention will be apparent from the following description, the accompanying drawings and the appended claims.

### BRIEF DESCRIPTION OF THE DRAWINGS

FIG. 1 is a perspective view of a soil conditioning farm implement constructed in accordance with the invention and in its operating position;

FIG. 2 is an enlarged fragmentary rear view of the implement shown in FIG. 1;

FIG. 3 is an enlarged perspective view of a hinge connection and actuating cylinder for the left wing section of the implement shown in FIGS. 1 & 2;

FIG. 4 is a rear elevational view of the implement with the wing sections folded upwardly and inwardly to parallel horizontal tandem positions over the center section and with the wheels lowered for transport;

FIG. 5 is a plan view of the center section of the implement with the wing sections shown in phantom over the center section in their storage and transport positions, as also shown in FIG. 4;

FIG. 6 is a vertical section taken generally on the line 6-6 of FIG. 1 and showing the suspended support of a set of soil conditioning rollers in accordance with the invention; and

FIG. 7 is a fragmentary section of the implement tongue shown in FIGS. 1 and 5 and with a forward section of the tongue pivoted upwardly to a storage position in accordance with the invention.

### DETAILED DESCRIPTION OF THE IMPLEMENT SHOWN IN THE DRAWINGS

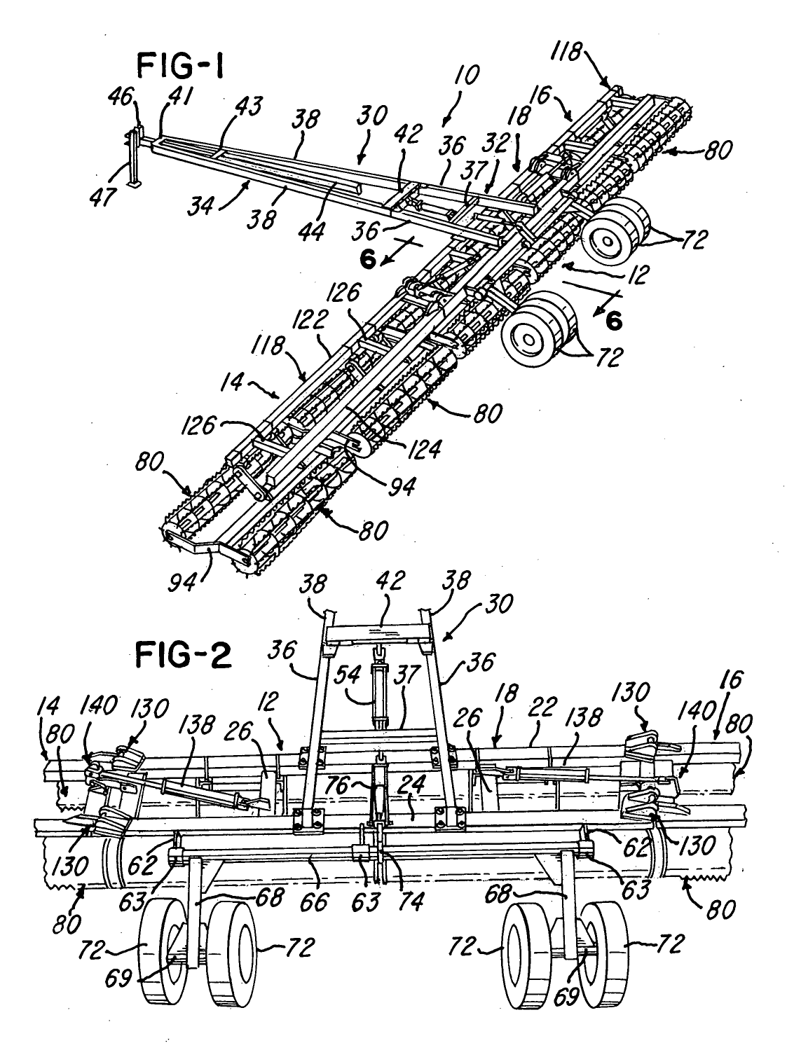

FIG. 1 illustrates a soil conditioning farm implement 10 including a center section 12 having opposite sides pivotally connected to folding wing sections 14 and 16. The center section 12 includes a fabricated steel frame 18 (FIGS. 2 & 3) formed by square tubular frame members 22 and 24 rigidly connected by a set of square tubular cross frame members 26. The frame 18 of the center section 12 also includes a forwardly projecting tongue 30 formed by a rearward section 32 and a forward section 34. The rearward section 32 has a pair of converging tubular steel members 36 which are secured by welded bottom plates and U-bolts to the frame members 22 and 24 of the center section 12, and the members 36 are rigidly connected by a cross member 37. The forward section 34 of the tongue 30 is formed by a pair of converging tubular steel members 38 rigidly connected by a front end cross member 41 and a rearward cross member 42 and an intermediate cross member 43. The forward tongue section 34 also supports a telescopic tubular tongue extension member 44 which extends through openings within the cross members 41 and 43, and has a forward end rigidly connected to a hitch 46 for connecting the tongue 32 to a towing vehicle, such as the draw bar of a tractor. A temporary stand 47 (FIG. 1) supports the hitch 46 at a preselected elevation according the height of the draw bar and for receiving the draw bar.

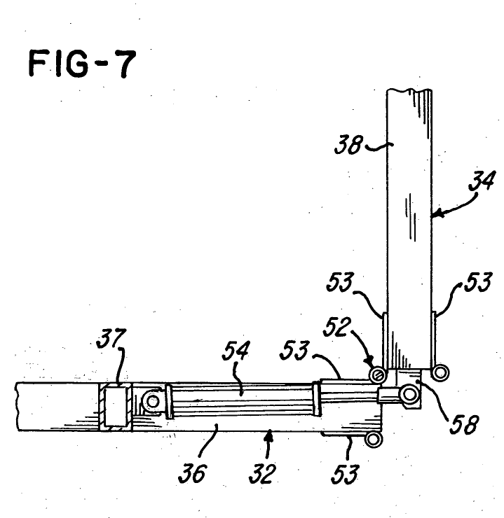

Referring to FIG. 7, the forward tongue section 34 is pivotally connected to the rearward tongue section 32 by a pivot hinge 52 having flanges 53 welded to the top surfaces of the tongue members 36 and 38. A fluid or hydraulic cylinder 54 is pivotally connected to the cross frame member 37 and has a piston rod pivotally connected to an arm or bracket 58 projecting rearwardly from the forward tongue section 34. When the cylinder 54 is actuated to extend the piston rod, the forward tongue section 34 pivots upwardly from its horizontal position (FIG. 1) to an upwardly projecting storage position, as shown in FIG. 7. When the tongue section 34 is in its horizontal lower position, the tongue sections 32 and 34 are locked together by a cross-pin (not shown) extending through another pair of hinge flanges 53 welded to the bottom surfaces of the tongue members 36 and 38. The tongue section 34 may also be pivoted by other means or member such as a cable winch.

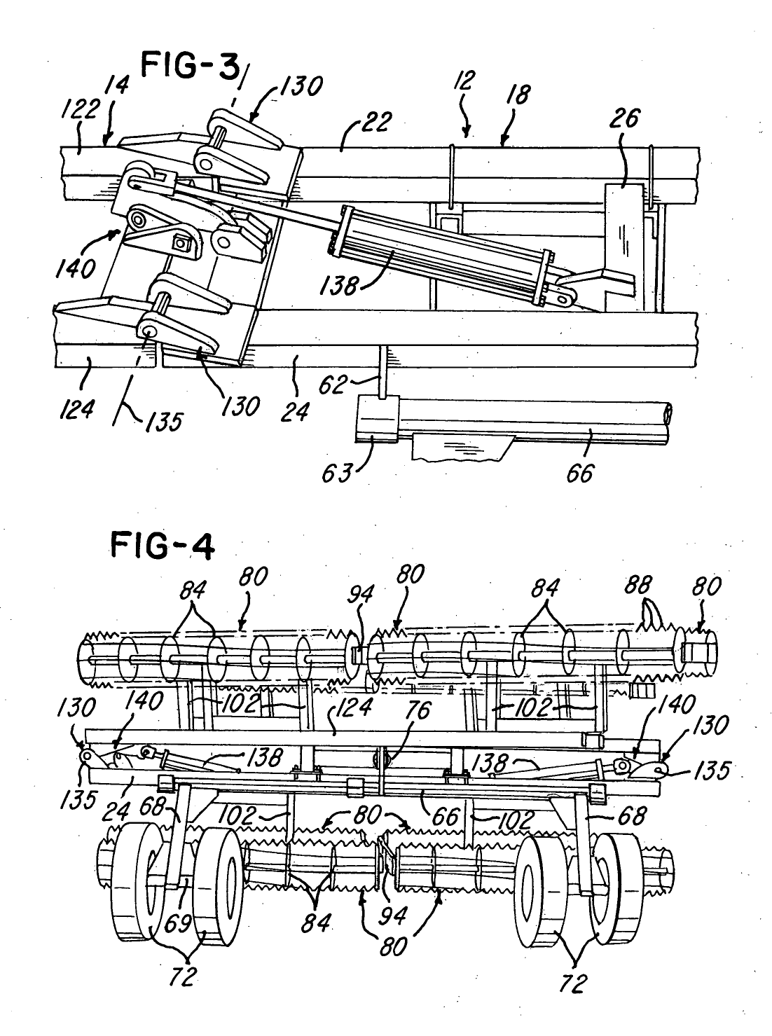

Referring to FIGS. 2 and 3, a set of three brackets 62 are welded to the rear frame member 24 of the center section 12 and include cylindrical bearing sleeves 63 which support a cylindrical tubular shaft 66 for rotation on a horizontal axis. A pair of arms 68 are welded to the shaft 66 and project downwardly and rearwardly from the shaft. Each arm is rigidly connected to a horizontal axle 69 on which is mounted a pair of resilient rubber tire wheels 72. A bracket or arm 74 is welded to the center of the shaft 66 and is pivotally connected to the piston rod of the fluid or hydraulic cylinder 76 pivotally connected to the front frame member 22 of the center section 12. Actuation of the cylinder 76 rotates the shaft 66 and moves the wheels 72 between an upper retracted position (FIG. 1) and a ground engaging position shown in FIGS. 2 and 4.

Referring to FIGS. 4 and 6, the center section 12 of the implement 10 supports two pair of elongated soil conditioning rollers 80 shown in the form of open rolling baskets constructed similar to those disclosed in above mentioned Patent No. 5,839,516. Each of the rollers 80 has a center shaft 82 which supports a plurality of axially spaced circular discs 84 on which are mounted a plurality of circumferentially spaced elongated blades 86. The blades extend in a slight helical path along the length of each roller 80, and each blade 86 has longitudinally spaced V-shaped teeth 88 for engaging the ground or soil. Each pair of rollers 80 is supported by a roller support frame 92 (FIG. 6) formed by laterally spaced horizontal arms 94 rigidly connected by a tubular frame member 96. As shown in FIG. 1, each of the arms 94 has offset end portions for supporting the front roller 80 axially offset from the rear roller 80 so that the soil between opposing ends of the front pair of rollers 80 is engaged by a rear roller 80.

As also shown in FIG. 6, each of the roller support frames 92 is supported in a horizontal suspended position by a pair of laterally spaced support arms 102. The lower portions of each pair of support arms 102 are connected to the roller support frame 92 by a rubber torsion bar axle 105 of the type disclosed in U.S. Pat. No. 3,436,069, No. 5,277,450 and No. 5,411,287, the disclosures of which are herein incorporated by reference. The opposite end portions of the square center shaft 106 of each axle 105 are rigidly connected to the arms 102 and the outer square or cylindrical housing of the axle 105 is rigidly connected to the roller support frame 92 by a pair of laterally spaced welded brackets or plates 108.

Similarly, the upper end portions of each pair of arms 102 are connected to the frame 18 of the center section 12 by another rubber torsion bar axle 105. The opposite end portions of the square center shaft 106 are rigidly connected to the arms 102, and the outer square or cylindrical housing is secured to the rear frame member 24 by a pair of L-shaped brackets 110 and a pair of U-bolts 112. The upper and lower or dual rubber torsion axles 105 are constructed to provide predetermined torque to the shafts 106 and cooperate to support and bias the roller support frame 92 and rollers normally in a horizontal position parallel with the frame 18, as shown in FIG. 6. The torsion axles 105 also permit the roller support frame 92 to move upwardly and downwardly relative to the frame 18 as well as tilt forwardly and rearwardly so that the rollers 80 may accommodate different ground contours and will ride over upwardly projecting stones and debris on the ground.

Referring to FIG. 1, each of the wing sections 14 and 16 of the implement 10 includes a fabricated tubular frame 118 constructed or fabricated in the same manner as the frame 18, including a front tubular frame member 122 and a rear tubular frame member 124 rigidly connected by a pair of laterally spaced cross frame members 126. Each frame 118 supports two pairs of front and rear soil engaging rollers 80 in the same manner as described above in connection with FIG. 6 and the support of the rollers 80 by the center frame section 18. Referring to FIG. 3, the frame 118 of each wing section 14 and 16 is pivotally connected to the frame 18 of the center section 12 by a pair of hinges 130. The hinges 130 pivotally connect the frame members 122 and 124 to the corresponding frame members 22 and 24 and have hinge plates welded to the frame members.

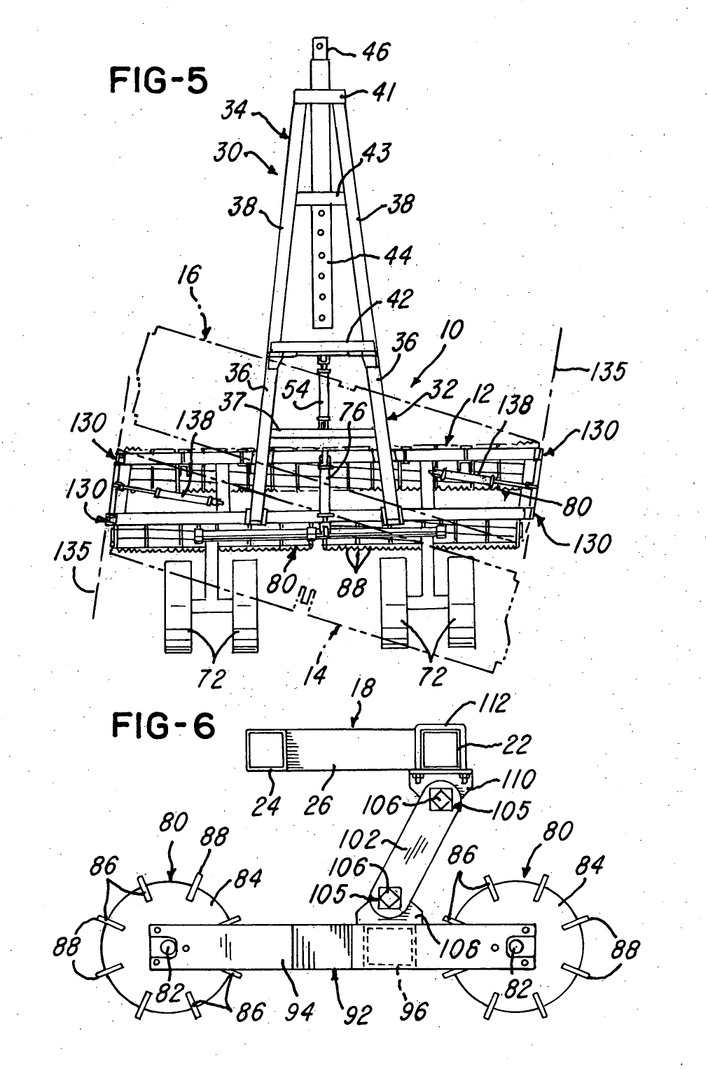

As shown in FIGS. 3 and 5, the hinges 130 for each wing section have an aligned pivot axis 135, and the axes for both wing sections are parallel and canted or angled at an acute angle with respect to a centerline of the tongue 30. The acute angle is within the range of 5 degrees and 20 degrees and preferably about nine degrees so that when the wing sections 14 and 16 are pivoted upwardly and inwardly to their folded positions for storage in response to actuation of the fluid or hydraulic cylinder 138 and pivot lever mechanism 140, the wing sections extend in parallel spaced and in horizontal tandem relation diagonally across the center section 12, as shown in FIGS. 4 and 5. Thus in the folded stored positions, the shafts 82 of the rollers 80 on the wing sections 14 and 16 define substantially a horizontal plane, as shown in FIG. 4. The diagonal parallel arrangement of the folded wing sections 14 and 16 also provide for minimizing the overall width of the implement 10 when it is in its folded position and provide for longer wing sections. For example, an implement having an overall width of 40 feet in its operating position, as shown in FIG. 1, collapses to a width of under 14 feet in a folded position, as shown in FIG. 5.

From the drawings and the above description, it is apparent that a soil conditioning implement constructed in accordance with the invention, provides desirable features and advantages. As mentioned above, by positioning the parallel axes 135 of the hinges 130 at an acute angle with respect to the centerline of the tongue 30, the wing sections 14 and 16 are folded by the cylinders 138 and lever mechanisms 140 to a flat horizontal and tandem collapsed position as shown in FIG. 4 for storage and transport of the implement. This minimizes the overall height of the implement during transport and storage so that the driver of a towing vehicle or tractor has an unobstructed rear view over the implement while traveling down a road. The low overall height of the implement in its folded position also enables the implement to be transported on a flatbed truck while minimizing the overall combined height of the implement and the truck. The parallel angled positions of the collapsed wing sections also permits longer wing sections.

The upper and lower rubber torsion axles 105 for each set or pair of rollers 80, as shown in FIG. 6, further provide for independent vertical movement of each of the rollers 80 as well as vertical and tilting movement of both rollers as a unit so that the rollers 80 follow the contour of the ground. This assures a substantially uniform pressure of the rollers against uneven ground and absorbs shock forces due to rocks and debris on the ground. The biasing forces of the upper and lower torsion axles also eliminates costly replacement of corroded coil springs. The combination of a telescopic and folding tongue further cooperates with the folding wing sections to minimize the space required for storage of the implement in a building.

While the form of soil conditioning implement herein described constitutes a preferred embodiment of the invention, it is to be understood that the invention is not limited to this precise form of implement, and that changes may be made therein without departing from the scope and spirit of the invention as defined in the appended claims.

What is claimed is:

1. A farm implement for conditioning soil, comprising a wheel supported center section having a frame including an elongated tongue adapted to be coupled to a towing vehicle, a pair of laterally extending elongated wing sections having frames pivotally connected by hinges to opposite sides of said frame of said center section, power operated members connected to pivot said wing sections relative to said center section, said frame of each of said sections supporting at least one elongated soil engaging member on a substantially horizontal axis, said hinges having generally parallel pivot axes extending at an acute angle with respect to a centerline of said tongue, and said hinges and said power operated members positioned to provide for pivoting said frames and said soil engaging members of said wing sections between laterally outwardly projecting operating positions and folded collapsed positions with said rollers in tandem relation and having axes of rotation defining generally a horizontal plane.

2. An implement as defined in claim 1 wherein said soil engaging members comprise soil engaging rollers, said frame of each of said wing sections supports a plurality of laterally spaced said soil engaging rollers, and all of said rollers in said operating positions have generally aligned axes of rotation substantially perpendicular to said centerline of said tongue.

3. An implement as defined in claim 2 wherein said frame of each of said center and wing sections supports a front soil conditioning roller and a rear soil conditioning roller having substantially parallel axes of rotation, and said front and rear rollers on each said wing section define generally a horizontal plane when said wing section is in said folded collapsed position.

4. An implement as defined in claim 1 wherein said soil engaging members comprise soil engaging rollers, said frame of each of said center and wing sections supports a front soil conditioning roller and a rear soil conditioning roller having substantially parallel axes of rotation, a roller support frame for each set of said front and rear rollers, a set of depending and laterally spaced support arms for each of said roller support frames, an upper rubber torsion bar axle connecting each said set of support arms to said frame of one of said sections, and a lower rubber torsion bar axle connecting each said set of support arms to a corresponding said roller support frame.

5. An implement as defined in claim 1 wherein said elongated tongue includes a forward section pivotally connected to a rearward section, and an operating member connected to tilt said forward section between a generally horizontally towing position and an upwardly projecting storage position.

6. An implement as defined in claim 5 wherein said forward section of said tongue includes a telescopically supported tongue extension member movable between a forward extended position and rearward retracted position within said forward section of said tongue.

7. A farm implement for conditioning soil, comprising a wheel supported center section having a frame including an elongated tongue adapted to be coupled to a towing vehicle, a pair of laterally extending elongated wing sections having frames pivotally connected by hinges to opposite sides of said frame of said center section, power operated members connected to pivot said wing sections relative to said center section, said frame of each of said sections supporting a front soil conditioning roller and a rear soil conditioning roller having substantially parallel axes of rotation, a roller support frame for each set of said front and rear rollers, a set of depending and laterally spaced support arms for each of said roller support frames, an upper rubber torsion bar axle connecting each said set of support arms to said frame of one of said sections, a lower rubber torsion bar axle connecting each said set of support arms to a corresponding said roller support frame, and said hinges providing for pivoting said frames and said soil engaging rollers of said wing sections between laterally outwardly projecting operating positions and folded collapsed positions overlying said center section.

8. An implement as defined in claim 7 wherein said frame of each of said center and wing sections supports a plurality of laterally spaced said soil engaging rollers, and all of said rollers in said operating positions have generally aligned axes of rotation generally perpendicular to said centerline of said tongue.

9. An implement as defined in claim 7 wherein said axes of rotation of said front and rear rollers on each said wing section define generally a horizontal plane when said wing section is in said folded collapsed position.

10. An implement as defined in claim 7 wherein said hinges have generally parallel pivot axes extending at an acute angle with respect to a centerline of said tongue to position said wing sections in tandem relation in said folded collapsed positions, and said axes of rotation of said rollers on said wing sections define generally a horizontal plane in said folded collapsed positions.

11. An implement as defined in claim 7 wherein said elongated tongue includes a forward section pivotally connected to a rearward section, and an operating member connected to tilt said forward section between a generally horizontally towing position and an upwardly projecting storage position.

12. An implement as defined in claim 11 wherein said forward section of said tongue includes a telescopically supported tongue extension member movable between a forward extended position and rearward retracted position within said forward section of said tongue.

13. A farm implement for conditioning soil, comprising a wheel supported center section having a frame including an elongated tongue adapted to be coupled to a towing vehicle, a pair of laterally extending elongated wing sections having frames pivotally connected by hinges to opposite sides of said frame of said center section, power operated members connected to pivot said wing sections relative to said center section, said frame of each of said sections supporting a soil conditioning roller having an axis of rotation, a roller support frame for each said roller and including a set of depending and laterally spaced support arms, an upper rubber torsion bar axle connecting each said set of support arms to said frame of one of said sections, a lower rubber torsion bar axle connecting each said set of support arms to a corresponding said roller support frame, and said hinges providing for pivoting said frames and said soil engaging rollers of said wing sections between laterally outwardly projecting operating positions and folded collapsed positions overlying said center section.

14. An implement as defined in claim 13 wherein said frame of each of said center and wing sections supports a plurality of laterally spaced said soil engaging rollers, and all of said rollers in said operating positions have generally aligned axes of rotation generally perpendicular to said centerline of said tongue.

15. An implement as defined in claim 13 wherein said axes of rotation of said rollers on said wing sections define generally a horizontal plane when said wing sections are in said folded collapsed position.

16. An implement as defined in claim 7 wherein said hinges have generally parallel pivot axes extending at an acute angle with respect to a centerline of said tongue to position said wing sections in tandem relation in said folded collapsed positions, and said axes of rotation of said rollers on said wing sections define generally a horizontal plane in said folded collapsed positions.

17. A farm implement for conditioning soil, comprising a wheel supported center section having a frame including an elongated tongue adapted to be coupled to a towing vehicle, a pair of laterally extending elongated wing sections having frames pivotally connected by hinges to opposite sides of said frame of said center section, power operated members connected to pivot said wing sections relative to said center section, said frame of each of said sections supporting at least one elongated soil engaging roller for rotation on a substantially horizontal axis, said elongated tongue includes a forward section pivotally connected to a rearward section, an operating member connected to tilt said forward section between a generally horizontally towing position and an upwardly projecting storage position, and said hinges providing for pivoting said frames and said soil engaging rollers of said wing sections between laterally outwardly projecting operating positions and folded collapsed positions overlying said center section.

18. An implement as defined in claim 17 wherein said forward section of said tongue includes a telescopically supported tongue extension member movable between a forward extended position and rearward retracted position within said forward section of said tongue.

19. An implement as defined in claim 17 wherein said frame of each of said center and wing sections supports a front soil conditioning roller and a rear soil conditioning roller having substantially parallel axes of rotation, and said front and rear rollers on each said wing section define generally a horizontal plane when said wing section is in said folded collapsed position.

20. An implement as defined in claim 17 wherein said frame of each of said center and wing sections supports a front soil conditioning roller and a rear soil conditioning roller having substantially parallel axes of rotation, a roller support frame for each set of said front and rear rollers, a set of depending and laterally spaced support arms for each of said roller support frames, an upper rubber torsion bar axle connecting each said set of support arms to said frame of one of said sections, and a lower rubber torsion bar axle connecting each said set of support arms to a corresponding said roller support frame.
